(19) United States
(12) Patent Application Publication
(10) Pub. No.: US 2021/0233341 A1
(43) Pub. Date: Jul. 29, 2021

(54) DIGITAL IDENTIFICATION VALIDATION SYSTEM

(71) Applicants: Eric Hayes, Mankato, MN (US); Kyle Schreier, Chanhassen, MN (US); Thomas O'Neill, Excelsior, MN (US)

(72) Inventors: Eric Hayes, Mankato, MN (US); Kyle Schreier, Chanhassen, MN (US); Thomas O'Neill, Excelsior, MN (US)

(21) Appl. No.: 17/153,234

(22) Filed: Jan. 20, 2021

Related U.S. Application Data
(60) Provisional application No. 62/964,944, filed on Jan. 23, 2020.

(51) Int. Cl. G07C 9/20; G06K 7/14

(52) U.S. Cl. CPC G07C 9/20; G06K 7/1413

(57) ABSTRACT

The invention is directed, in part, to a system or method for validating identification cards of a person using the card to establish their identity or age so as to be allowed to enter a facility, purchase a product; or participate in a service. In an example, the validation relates to whether a person can purchase or consume alcohol, the system comprising: scanning the identification card, review of information on the identification card; evaluating the age on the identification card; wherein the age on the identification card is used to establish whether a person with the identity card is eligible to purchase and consume alcohol.

This application claims the benefit of U.S. Provisional Application No. 62/964,944, filed Jan. 23, 2020, the content of which is herein incorporated by reference in its entirety.

### FIELD OF THE INVENTION

The present disclosure relates to systems and methods for validating identification cards, including validation of identification cards for entering establishments that serve alcohol, including application programing interfaces for the same.

### BACKGROUND

Many enterprises, such as businesses, non-profit organizations, service providers, and government agencies find it necessary to confirm the identity and eligibility of individuals who seek to enter their premises and/or participate in services from the organization. For example, many bars, restaurants, sporting venues, concert halls, nightclubs, liquor stores, and other venues etc. are mandated by law to only sell alcohol to persons of a specific age, typically 21 years in the United States. These enterprises take on significant legal, regulatory, and safety risks related to selling; and serving alcohol. In the event that underage persons are sold or served alcohol the enterprise can face legal prosecution and potential loss of its ability to sell alcohol. In addition, selling or serving alcohol to underage persons can result in liability if the recipient commits an accident or in some other manner causes harm to themselves, to others or to property.

These risks reflect directly in the costs to insure and manage these businesses. Most venues rely on bouncers, bartenders, and other customer facing employees to manage access to alcohol and mitigate these risks. These employees must be trained in how to review identification, including how to identify fake identification cards. Relying only on human judgement leaves room for error in the processes related to controlling access and limiting risks. This is a significant challenge in some circumstances, even for seasoned people in the industry. It is even harder for people with less experience in the industry, such as temporary employees who may be hired at short term events, such as sporting events.

Similarly, other enterprises often sell other products that have requirements as to who can purchase them. An example would be certain over-the counter pharmaceuticals that have age and quantity limits; or sales of products (such as paints) that contain controlled solvents. Also, prescription pharmaceuticals often require showing of identification by the purchaser. Similarly, tobacco purchase often require proof of age, and marijuana is legal in many jurisdictions but also has age limits on who can purchase.

It would be advantageous to owners, operators, and employees of these enterprises and venues to have tools to facilitate consistent and accurate review of identification so that they can properly control access and limiting risks associated to selling and serving alcohol, or other products or services.

### SUMMARY OF THE INVENTION

The present disclosure is directed to a digital identification system for review of identification cards. The system includes, in various implementations, equipment and processes for a scanning, validation, and verification system; including applications that can run on individual devices but be networked together. Also, the system can include in certain embodiments an application programming interface (API) that allows the technology described herein to be used in various forms and formats with a range of computer interfaces.

The system includes, in certain embodiments, a digital tool built to facilitate the processes related to providing security by security professionals such as bouncers, doorman, servers, guards and others employed at venues such as bars, nightclubs, concerts, liquor stores, or other businesses that regulate access. The system and methods assist these professionals in checking legal age, validating authenticity of identification, refusing entry and/or service to patrons of risk, and tracking patrons that violate policies or other incidents that put other patrons or the venue at risk.

The disclosure is also directed, in part, to a method for validating identification cards of a person using the card to establish their age or identity for various purposes, such as to be allowed to purchase or consume alcohol, comprising: scanning the identification card, review of information on the identification card (including, typically, validation); and evaluating the age on the identification card; wherein the age on the identification card is used to establish whether a person with the identity card is eligible to purchase and consume alcohol.

In certain implementations the identification card comprises a state or federal-issued identification card, including a driver's license, passport card, passport book, school identification card, health insurance card, public transportation card, employee identification card or other identification card. Scanning of the identification card typically comprises scanning the front and back of the identification card, sometimes including scanning one or more barcodes on the identification card. The barcodes can be, for example, on the front, back, or both the front and back. The means for scanning an identification card can be a portable tablet device, such as a phone with a camera.

Review of information on the identification card comprises review of the birth date on the identification card. Review of information on the identification card can include review of the gender, address, photograph, or other feature on the identification card. Evaluating the age on the identification card comprises determining the number of years since the person bearing the card was born.

In certain implementations a photograph of the entire identification card (optionally just the front, or the front and the back) is taken, and then this photograph of the identification card can be used for various validation, verification, and screening purposes. For example, the photograph of the identification card, and the data on it, can be immediately used to determine whether or not the same card has been used to enter a nearby establishment in the recent past, whether the bearer of the same card has been recently turned away or removed from a nearby establishment, or if there have been other problems associated with that identification card or patron. For example, in some embodiments the photograph (and optionally related information on the card) is compared to a database of other cards recently used in local establishments, such as checked against a set number of establishments or a set geography of establishments that are using the same system. In an example implementation the information is checked against the five nearest establishments that are part of the network. This check can be used to see if the user has been turned away at one or more of those jurisdictions, in which case the system alerts the user (such as the person monitoring admission to the establishment) that the same identification card has been used to gain improper access to another nearby facility. This feature is beneficial because often a person will go from establishment to establishment with a fake or altered identification until they get into one. The system, by having a networked set of users with screening equipment, can become more efficient and effective at excluding persons without proper identification that have been turned away from other establishments.

Similarly, the use of the system and network allows for an establishment to exclude a person who has been removed from a nearby establishment, such as for fighting. When a person is removed from a facility the establishment can call up the person's identification and flag them for exclusion at other networked facilities. This can be a particularly valuable feature because hostile and belligerent patrons can be a hazard to other patrons, to employees, and to themselves. Flagging those belligerent patrons allows for increased safety and security. It will be understood that this flagging of patrons that are to be excluded is particularly possible because a photograph of the identification card is kept on file and can be quickly called up in the event that a patron is removed from the facility, and then that record is flagged for other networked users. Without the identification tracking this feature would not be possible. For example, without the identification tracking it may only be possible to use appearance of the person, such as “tall male, red hair, wearing a green coat” because the establishment's employees may not know the patron's name. Plus, the establishment has no way of readily sharing that information that is not cumbersome and prone to error. The problem can be particularly difficult if the former patron changes their appearance, such as taking off their blue coat (in this hypothetical example) after being kicked out of a first establishment. In contrast, using the present system and method, once a patron is removed from a facility the employees can quickly look up the records of recent patrons, flag the record for the removed patron, at which point all nearby facilities have an immediate, accurate, and secure way of stopping this person from admission to their facilities.

Flagging of identification can be used for other purposes besides removing a person from a premises. For example, the flagging can be used to identify an individual has improperly sought to buy cigarettes or other controlled goods. Those people may not be excluded from a premise (such as a convenience store), but flagging of their identification may facilitate identification of them in the future for improper purchase attempts. Similarly, the flagging can be used for limiting multiple purchase of an item where limits are imposed (such as some solvents, fertilizers, pharmaceuticals, etc.).

These flagging steps have the added benefit of being potentially shared with other users of the system, thereby putting them on notice of improper behavior or that cumulative limits for purchases have been reached.

A further benefit of recording the identification of patrons is that this record can be used to prove that an identification was checked when a patron entered a facility or making a purchase (for example). This is useful to demonstrate the facility's compliance with legal age limits. For example, when law enforcement agents identify an underage drinker (such as an undercover investigation at a bar), the underage drinker will sometimes state that their identification was never checked. By having a record of the identification, the establishment can prove this statement by the underage patron to be false, and prove that a fake identification card was used (but w/o knowledge of the establishment, since the card showed a legal age for the patron). This record can also be used by the establishment in the unfortunate situation where an underage patron uses a fake identification card to gain admission to an establishment and then is involved in an accident or injury-causing situation. The digital record (photograph) of the identification card proves that the patron was screened using best available methods and technology, and thus it was not the establishment's fault that the underage patron was served alcohol.

In a further implementation of the present subject matter the system checks against a government database for admission of a potential patron, in particular as to the age of the patron. This database can be, for example, from the department of motor vehicles (DMV), a local police or sheriff's database, other law enforcement databases, various local, state, and federal databases, or other databases maintained by third parties or by network administrators.

The method can further entail providing a challenge question based upon the information on the identification card. For example, the challenge question can be requesting information shown on the identification card, such as the birthday on the card, the street address on the card, the city or state on the card, the type of license (such as Class A, Class B, Class C), whether the card shows the bearer to be an organ donor, whether the card shows the bearer to have a known allergy, or whether the card shows the bearer is obligated to wear prescription glasses or contacts.

The challenge question can also involve requesting information deduced from information shown on the identification card but not explicitly shown on the card, such as the bearer's country based upon city and state; bearer's county based upon city and state; bearer's zodiac sign based upon birthday; or closest cross street to bearer's home address. These are all things that typically would be known to someone who is using their own identification card, but the information is not on the card itself. Such challenge questions can be generated by connecting to a database, such as a mapping database or database of zodiac signs. The challenge question can be provided in multiple choice format as well. In the event that the system is implemented as an API or similar interface, the challenge questions can be generated from a common database accessed by all API users.

### FIGURES

The invention may be more completely understood in connection with the following drawings, in which:

FIG. 1 shows two example identification cards (IDs), first a traditional card, and second a similar but “enhanced” card.

FIG. 2 shows a schematic of example components of a system for performing the methods described herein.

FIG. 3 shows a flow chart of example steps for performing a process described herein.

FIG. 4 shows a flow chart of example steps for determining if a person is of legal drinking age.

FIG. 5 shows a flow chart of an example identification authentication process.

FIG. 6 shows a flow chart of an example process for retrieving and comparing data from a database relating to an identification card.

While the invention is susceptible to various modifications and alternative forms, specifics thereof have been shown by way of example and drawings and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

The present systems and processes advantageously automate and enhance many of the human processes related to controlling access to various establishments and services, such as venues selling or serving alcohol. The systems and processes include the ability to provide digital age verification, visual/appearance identification, personal identification & identification card authenticity validation, and can provide card holder challenge questions,

In one aspect, the system and process are used to provide digital age verification. For example, when a customer enters an establishment they can be asked to present a valid identification card showing their birthdate, such as a state-issued identification card, often a driver's license. The operator will scan the identification card, capturing the data in the two-dimensional barcode on the card and a digital image of the identification card including the photograph of the identification card holder and all the personal information from the front of the identification card.

After capturing the personal information from the identification card, the system validates the authenticity of the identification card by comparing the information decoded from the two-dimensional barcode to the database decoded from the digital image of the identification card via character recognition.

In a next step in the example implementation, the system checks for an existing record of the identification card in the secure and encrypted database. If a record exists, the system can store record of the customers visit and return the customer's information from the database. If it is a new identification card, the system can create a new record. The database can store a unique record for each identification card scanned. In addition to the personal identifying information contained on the identification card, the system can store a digital image of the identification card including the photograph of the identification card holder and a status of the customer. The status record associated with the identification card.

After checking for an existing record, or creating a new record, the system can validate that the birthdate or other relevant information from the identification card meets the necessary requirements, such as legal drinking age requirement. If the age meets the requirement the system will display the identification card record including the current status message. If the age does not meet the requirement, the system will display the identification card record, status message, and an additional message indicating that the operator should deny access.

The present system and method has a unique advantage to other age verification tools in that it can store a digital image of the identification card including the card holder's identification card photo. This allows the operator to recall personal identification information via the card holder's appearance after the customer enters the venue.

In addition to validating the age on the identification card the system and method can help the operator validate that the identification card is the authentic identity of the card holder. Upon a successful scan, validation, and verification of an identification card the system can offer the operator an opportunity to be presented “challenge questions” to the card holder. If the operator chooses “challenge questions” the system will display several pre-configured questions related to the personal information related to the identity information on the identification card. For example, the system can generate questions like “which county are you from?” and it will display the actual answer based on the city and state on the identification card. The operator will be able to choose from the challenge questions to ask the card holder in order to validate the authentic identify of the card holder.

Underage patrons often use fake state issued identification cards. This can be a significant problem because serving underage patrons alcohol is a significant legal risk and liability. Insurance premiums for businesses holding alcohol licenses are significantly impacted by the probability of having an alcohol related incident. The present system and method digitally validates state issued identification cards for authenticity; and digitally validates state issued identification cards for legal age requirement alcohol consumption. The technology captures the card holder's photo as well as other identification information from an image of the state issued identification card and stores card holder information and photograph in an encrypted database for tracking and identification purposes.

The technology also allows an operator to store additional information, not otherwise on state issued identification card, associated with the card holder's information. For example, operator could identify car holder as VIP or flag them as a patron that violated policies or other incidents in the establishment.

The present technology also provides the ability to track incidents in the establishment by the patron's appearance along with traditional identification information.

The technology also provides the ability to associate security video with the patron's personal identification via the patron's appearance captured in the system and allows for employees identify return patrons by appearance.

Further, the technology validates personal identification information through character recognition from the image of the identification card and validates against the personal identification embedded into the barcode on the identification card.

Future improvements can include, but are not limited to, programmatic/systematic association of the patron record to video footage from security cameras to track the patron through their visit to the establishment. Associated video can be stored and encrypted for privacy only to be recalled automatically in case of an incident. Facial recognition at the establishment entrance can be used to identify return patrons and facilitate the entry process.

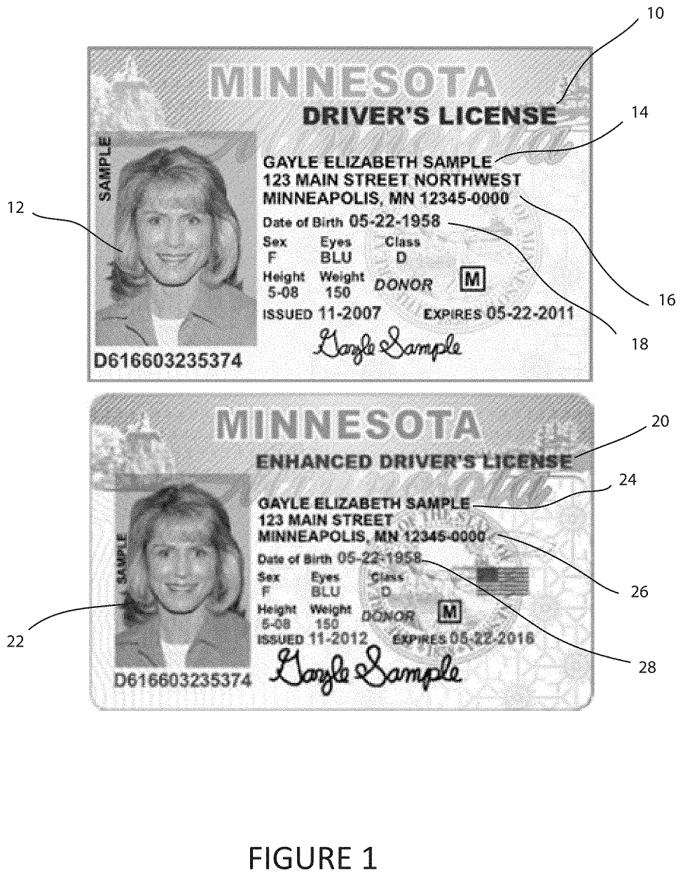

Referring now to FIG. 1, two example identification cards (IDs) are shown, first a traditional card, and second a similar but “enhanced” card. On the traditional card 10 is a photo 12 of the owner, their name 14, their address 16, and birth date 18. On the enhanced card 20 is a photo 22 of the owner, their name 24, their address 26, and birth date 28. The enhanced card typically also includes a radio frequency identification (RFID) chap embedded into the card with a unique number assigned to each card. ID cards also typically have one or more bar codes, often positioned on the back of the card, but alternatively or in addition positioned on the front of the card. Different jurisdictions have these bar codes in different locations. The system and method of the present application is able to recognize multiple bar codes, and can recognize different IDs from different jurisdictions.

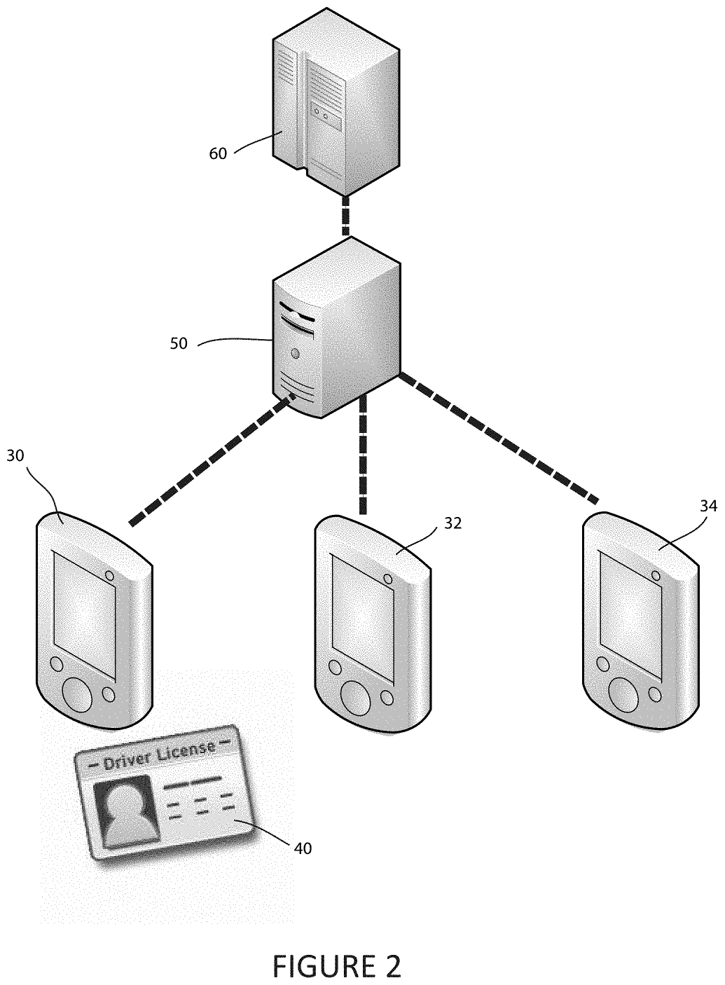

FIG. 2 shows a schematic of example components of a system for performing the methods described herein. Multiple portable devices 30, 32, 34 are provided, such as tablet computers with built in cameras. One such device is used to scan (capturing a photograph typically, optionally including reading RFID codes or other information) of ID 40. This information is fed to a server (either a local server connect into a local network or a wide area network) for processing. This processing can include, for example, transmitting or receiving information from a further server 60, such as a government server with validation information.

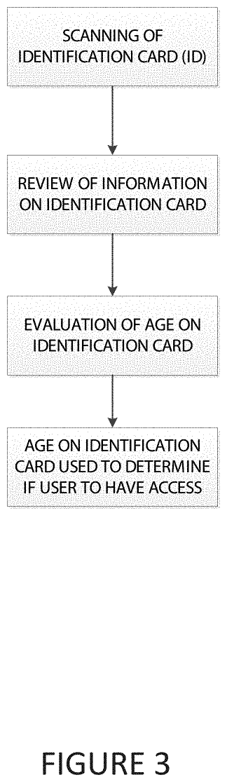

FIG. 3 shows a flow chart of example steps for performing the process described herein. These steps are generalized, but include a first step of scanning of the identification card, followed by review of information on the identification card (for example, using character recognition software to read name, address and birthdate), followed by evaluation of age on the identification card (calculating based on birth date), and subsequently determining if the user is to have access to the facility/be served alcohol.

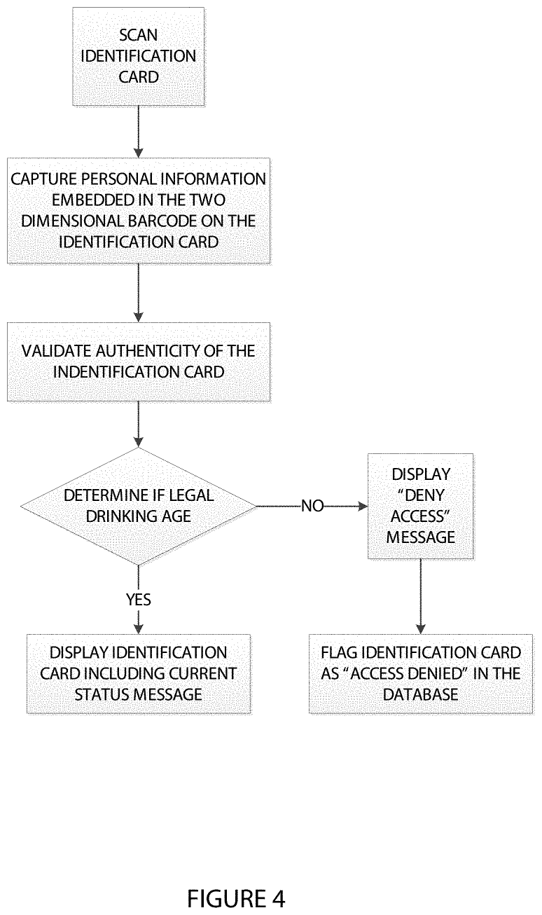

FIG. 4 shows a flow chart of example steps for determining if a person is of legal drinking age. The steps include, in this example, scanning the identification card, capturing personal information, validating the information, and determining if the bearer is of legal drinking age. If they are of legal drinking age a status message is displayed to allow entry. If not, a message is displayed to exclude access.

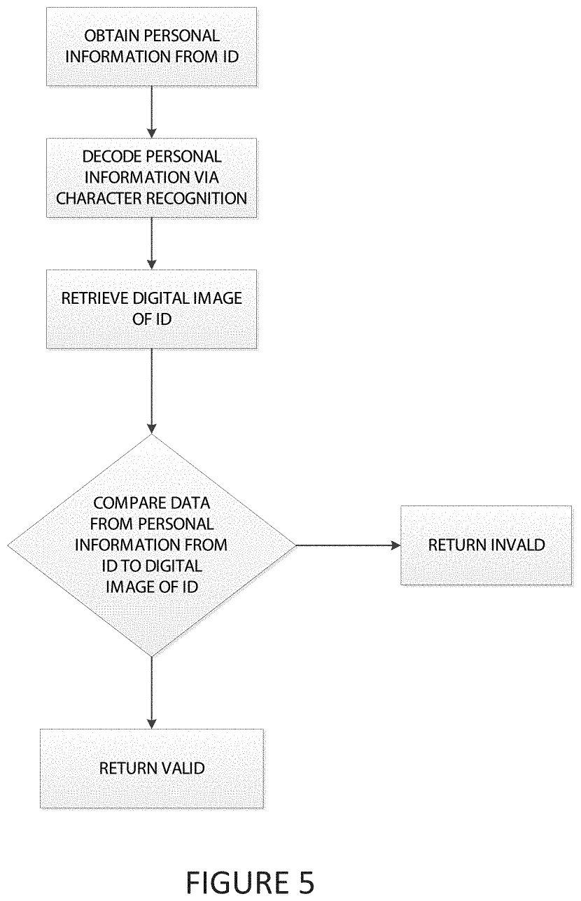

FIG. 5 shows a flow chart of an example identification authentication process. The method includes obtaining personal information from an ID, decoding the personal information via character recognition, retrieving a digital image of the ID, and comparing the data from personal information from the ID to a digital image of the ID.

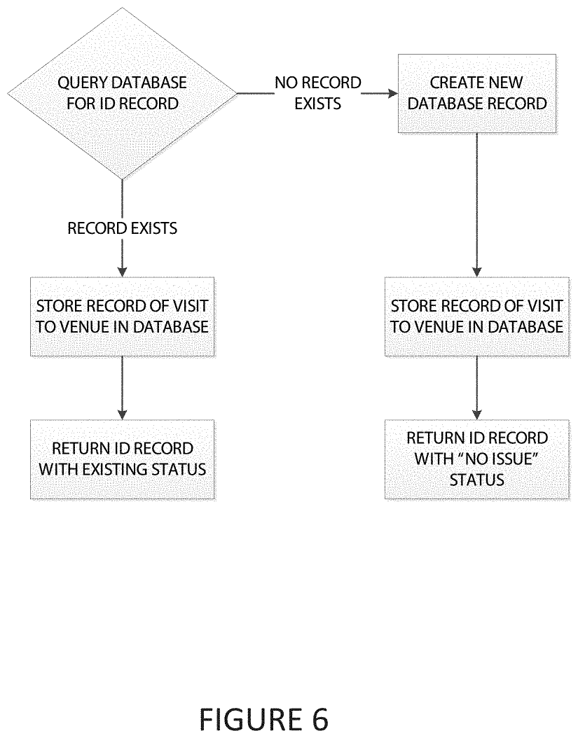

FIG. 6 shows a flow chart of an example process for retrieving and comparing data from a database relating to an identification card. The database is queried for whether a record exists. If not, a new record is crated and recorded. If the record does already exist, the record of visit to the venue is stored in the database and a record is returned with the existing status for that ID/person (such as admit or don't admit to the facility).

While the present invention has been described with reference to several particular implementations, those skilled in the art will recognize that many changes may be made hereto without departing from the spirit and scope of the present invention.

We claim:

1. A system for validating identification cards, the system comprising:
a means for scanning an identification card;
a means for review of information on the identification card;
a means for evaluating the age on the identification card;
wherein the age on the identification card is used to establish whether a person with the identity card is eligible to enter a facility, purchase a product, or participate in a service.

2. The system of claim 1, wherein the identification card comprises a state or federal-issued identification card, including a driver's license, passport card, passport book, global entry card, school identification card, health insurance card, or employee identification card.

3. The system of claim 1, wherein the means for scanning an identification card comprises a portable tablet device.

4. The system of claim 1, wherein the means for review of information on the identification card comprises review of the birth date on the identification card.

5. The system of claim 1, wherein the means for review of information on the identification card comprises review of the gender, address, photograph, or other feature on the identification card.

6. The system of claim 1, wherein the means for evaluating the age on the identification card comprises determining the number of years since the person bearing the card was born.

7. A method for validating identification cards of a person using the card to establish their age so as to be allowed to purchase or consume alcohol, the system comprising:
scanning the identification card,
review of information on the identification card;
evaluating the age on the identification card;
wherein the age on the identification card is used to establish whether a person with the identity card is eligible to purchase and consume alcohol.

8. The method of claim 7, further comprising review of information from the identification card for validity against a database.

9. The method of claim 7, wherein the identification card comprises a state or federal-issued identification card, including a driver's license, passport card, passport book, or global entry card.

10. The method of claim 7, wherein scanning of the identification card comprises scanning the front and back of the identification card.

11. The method of claim 7, wherein scanning of the identification card comprises scanning one or more barcodes on the identification card.

12. The method of claim 7, wherein the means for scanning an identification card comprises a portable tablet device.

13. The method of claim 7, wherein scanning an identification card comprises a cell phone.

14. The method of claim 7, review of information on the identification card comprises review of the birth date on the identification card.

15. The method of claim 7, wherein review of information on the identification card comprises review of the gender, address, photograph, or other feature on the identification card.

16. The method of claim 7, wherein evaluating the age on the identification card comprises determining the number of years since the person bearing the card was born.

17. The method of claim 7, further comprising providing a challenge question based upon the information on the identification card.

18. The method of claim 17, wherein the challenge question comprises requesting information shown on the identification card.

19. The method of claim 7 wherein the information shown on the identification card comprises the birthday on the card, the street address on the card, the city or state on the card, the type of license (such as Class A, Class B, Class C), whether the card shows the bearer to be an organ donor, whether the card shows the bearer to have a known allergy, or whether the card shows the bearer is obligated to wear prescription glasses or contacts.

20. The method of claim 7, wherein the challenge question comprises requesting information deduced from information shown on the identification card.

21.-25. (canceled)
